(19) United States
(12) Patent Application Publication
(10) Pub. No.: US 2022/0214663 A1
(43) Pub. Date: Jul. 7, 2022

(54) MULTI-AGENT AUTONOMOUS INSTRUCTION GENERATION FOR MANUFACTURING

(71) Applicant: The Boeing Company, Chicago, IL (US)

(72) Inventor: Joshua G. Fadaie, Saint Louis, MO (US)

(21) Appl. No.: 17/543,596

(22) Filed: Dec. 6, 2021

Related U.S. Application Data
(60) Provisional application No. 63/134,176, filed on Jan. 5, 2021.

(51) Int. Cl. G05B 19/4155

(52) U.S. Cl. CPC G05B 19/4155; G05B 2219/31368

(57) ABSTRACT

Solutions are provided for multi-agent autonomous instruction generation for manufacturing. An example includes: generating, for a plurality of actor agents, a first set of instructions for performing manufacturing tasks, wherein the actor agents include a human actor accessing a user interface (UI), an autonomous actor having a first sensor, a semi-autonomous actor having a second sensor, and a non-autonomous actor having a third sensor; receiving, by a control agent from at least the plurality of actor agents, observation data regarding performance of the actor agents on the manufacturing tasks, wherein the control agent comprises an autoregressive bidirectional long-term short-term memory (LSTM) attention network; and based at least on the instructions and the observation data, generating further instructions for performing manufacturing tasks. The instructions include at least one of a role assignment, platform control, tool selection, and tool utilization.

### CROSS-REFERENCE TO RELATED APPLICATION

This application claims the benefit of and priority to U.S. Provisional Application No. 63/134,176, entitled “MULTI-AGENT AUTONOMOUS INSTRUCTION GENERATION FOR MANUFACTURING”, filed Jan. 5, 2021, which is incorporated by reference herein in its entirety.

### BACKGROUND

Manufacturing of aircraft and other complex systems requires a significant amount of human touch (manual) labor, robotic-assisted manufacturing process, and coordination among the different processes. In some examples, rules-based or expert knowledge systems are used for control, including proportional-integral-derivative (PID) controllers that seek to minimize differences between observed and expected values. Even if autonomous subsystems are used, it is in a piecemeal fashion. Existing solutions typically involve high cost; require manual oversight of even autonomous vehicles, robots, and process flow; demonstrate limited flexibility in new environments and circumstances not explicitly programmed into the original design; and does do not adapt well to unplanned processes and procedures, such as the production of one-off parts or assemblies.

### SUMMARY

The disclosed examples are described in detail below with reference to the accompanying drawing figures listed below. The following summary is provided to illustrate examples disclosed herein. It is not meant, however, to limit all examples to any particular configuration or sequence of operations.

Solutions are provided for multi-agent autonomous instruction generation for manufacturing. An example includes: generating, for a plurality of actor agents, a first set of instructions for performing manufacturing tasks, wherein the actor agents include a human actor accessing a user interface (UI), an autonomous actor having a first sensor, a semi-autonomous actor having a second sensor, and a non-autonomous actor having a third sensor; receiving, by a control agent from at least the plurality of actor agents, observation data regarding performance of the actor agents on the manufacturing tasks, wherein the control agent comprises an autoregressive bidirectional long-term short-term memory (LSTM) attention network; and based at least on the instructions and the observation data, generating further instructions for performing manufacturing tasks. The instructions include at least one of a role assignment, platform control, tool selection, and tool utilization.

The features, functions, and advantages that have been discussed are achieved independently in various examples or are to be combined in yet other examples, further details of which are seen with reference to the following description and drawings.

### BRIEF DESCRIPTION OF THE DRAWINGS

The disclosed examples are described in detail below with reference to the accompanying drawing figures listed below:

FIG. 1 illustrates an arrangement 100 that advantageously employs multi-agent instruction generation, for example, multi-agent autonomous instruction generation for manufacturing, in accordance with an example.

FIG. 2 illustrates some internal details for a control agent 200 introduced in FIG. 1 as part of the arrangement 100, in accordance with an example.

FIG. 3 illustrates some step-wise operational details for the control agent 200 of FIGS. 1 and 2, in accordance with an example.

FIG. 4 illustrates an operational loop 400 for the control agent 200 of FIGS. 1 and 2, in accordance with an example.

FIG. 5 illustrates a learning structure 500 that may be used for the control agent 200 of FIGS. 1 and 2 in the operational loop 400 of FIG. 4, in accordance with an example.

FIG. 6 illustrates additional operational details for the control agent 200 of FIGS. 1 and 2, in accordance with an example.

FIG. 7 is a flow chart 700 illustrating a method of multi-agent instruction generation, as may be used with the arrangement 100 of FIG. 1, in accordance with an example.

FIG. 8 is a flow chart 800 illustrating another method of multi-agent instruction generation, as may be used with the arrangement 100 of FIG. 1.

FIG. 9 is a block diagram of a computing device 900 suitable for implementing various aspects of the disclosure.

FIG. 10 is a block diagram of an apparatus production and service method 1000 that advantageously employs various aspects of the disclosure.

FIG. 11 is a block diagram of an apparatus 1100 for which various aspects of the disclosure may be advantageously employed.

FIG. 12 is a schematic perspective view of a particular flying apparatus 1101.

Corresponding reference characters indicate corresponding parts throughout the drawings.

### DETAILED DESCRIPTION

The various examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one implementation” or “one example” are not intended to be interpreted as excluding the existence of additional implementations that also incorporate the recited features. Moreover, unless explicitly stated to the contrary, examples “comprising” or “having” an element or a plurality of elements having a particular property could include additional elements not having that property.

A centralized artificial intelligence (AI) or machine learning (ML) control agent is capable of collaboratively controlling multiple (a plurality of) actor agents and sensor agents to increase automation and human-machine collaboration within a manufacturing environment. The control agent learns to attend to relevant sources of situational awareness derived from various autonomous, semi-autonomous, non-autonomous, Internet of Things (IoT) devices, and human systems in order to intelligently command and control various platforms. These platforms may be robotic armatures, ground based vehicles, gimbaled measurement or vision systems and aerial vehicles (e.g., UAVs), connected via various IoT devices.

Aspects of the disclosure are able to advantageously automate manufacturing procedures and concepts operations through a centralized learning system and associated training and utilization processes through which the collective knowledge of various autonomous, semi-autonomous, non-autonomous, and human systems is collected through observations and is aggregated and utilized to intelligently inform commands issued to controllable vehicles, robots, and IoT devices. Aspects of the disclosure present novel solutions that reduce the cost and labor required to assemble and fabricate equipment and structures within a manufacturing environment.

Aspects of the disclosure present novel solutions that construct a superior situational awareness enabling intelligent autonomous control of large numbers of agents. The range of control may extend from a portion of a factory to spanning multiple factories. Actors may be controlled via roles, sub-roles, platform control, tool selection, tool utilization, and others, any of which may be masked. Lower level actions of actors are conditioned on higher level actions of actors. The queue for tasks or jobs may vary in length, as necessary.

Inputs include observations from the manufacturing environment and prior outputs. Observations (passive and interactive) are input and transformed by AI into control commands. The control agent (which may be local or remote) receives information from various devices it controls or can receive information from or provide feedback to a human via a user interface (UI). Some agents, (e.g., humans) may mask certain jobs, for example limiting the available actions for a given actor. For example, a human may mask an operation requiring the use of a particular tool if the human notices that the tool is not functioning properly.

An autoregressive, temporal and attention-based encoder-decoder deep reinforcement learning system includes a sequenced bi-directional long short-term memory (LSTM) based encoder, encoder-to-decoder attention network, and an LSTM based decoder. The decoder LSTM unrolls at each time-step per each controllable agent receiving an attention-based context vector, action masks (dictating legal actions) and other sources as input. The decoder is multi-head auto-regressive, such that actions (per each time step) may be conditioned on prior actions determined (within the same time-step). Deep reinforcement learning and system-level interaction among different data feeds, control units, and interfaces, provide an ability to improve performance through automated and human-assisted learning. AI learns from rewards, based on controlling actors to accomplish tasks properly. Rewards may result from feedback on results that correlate with control actions (instructions).

Aspects and implementations disclosed herein are directed to solutions for multi-agent autonomous instruction generation for manufacturing. An example includes: generating, for a plurality of actor agents, a first set of instructions for performing manufacturing tasks, wherein the actor agents include a human actor accessing a UI, an autonomous actor having a first sensor, a semi-autonomous actor having a second sensor, and a non-autonomous actor having a third sensor; receiving, by a control agent from at least the plurality of actor agents, observation data regarding performance of the actor agents on the manufacturing tasks, wherein the control agent comprises an autoregressive bidirectional LSTM attention network; and based at least on the instructions and the observation data, generating further instructions for performing manufacturing tasks. The instructions include at least one of a role assignment, platform control, tool selection, and tool utilization.

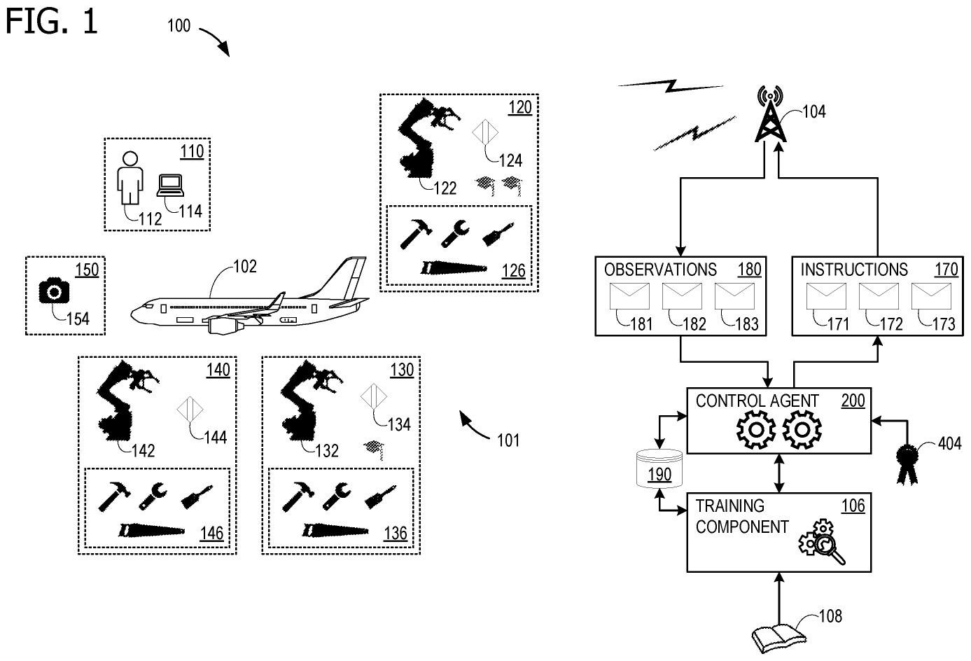

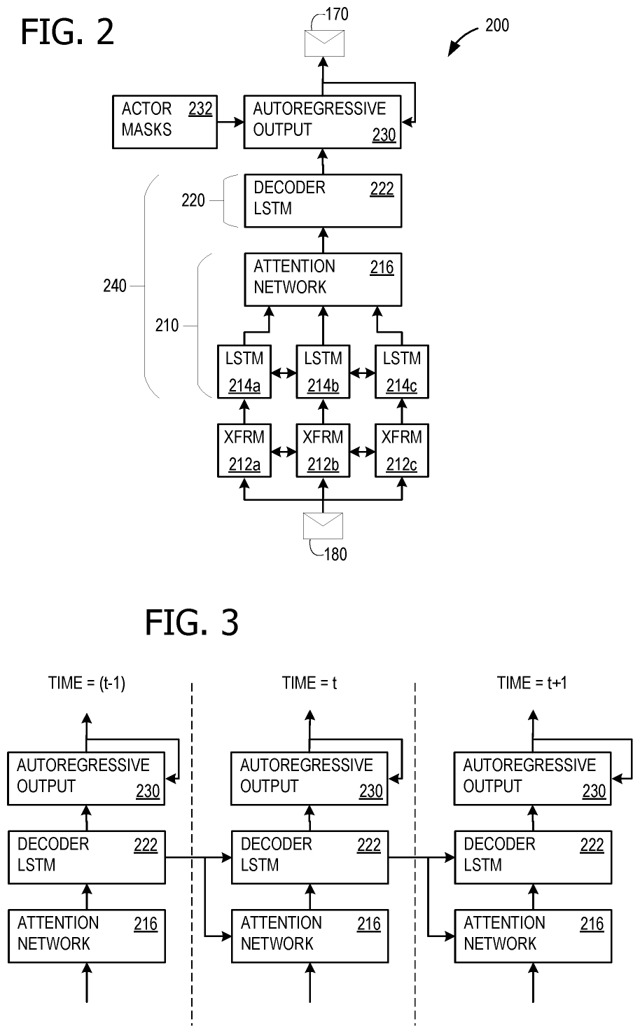

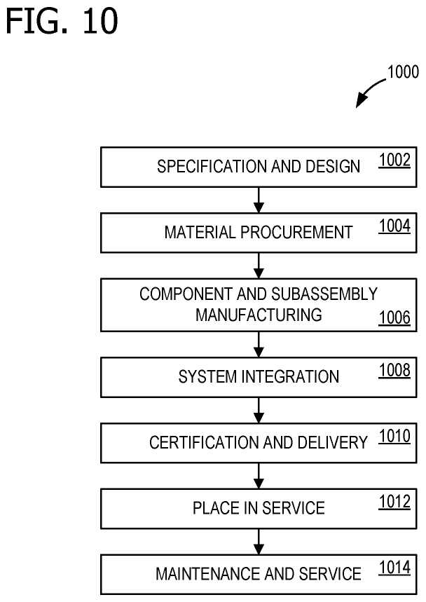

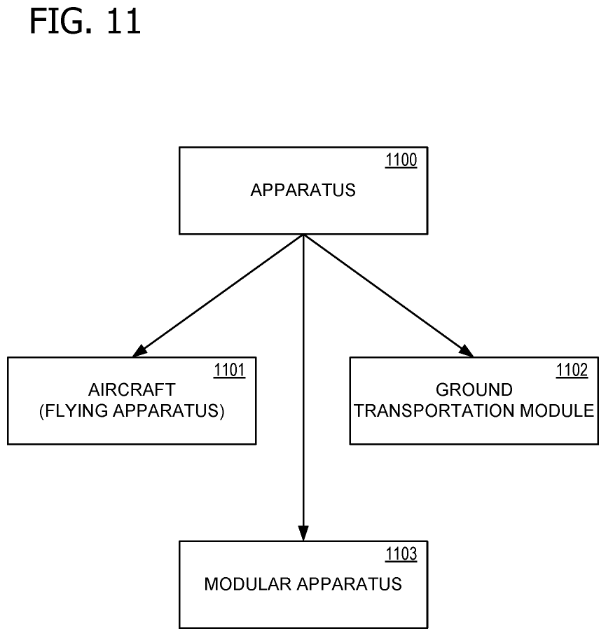

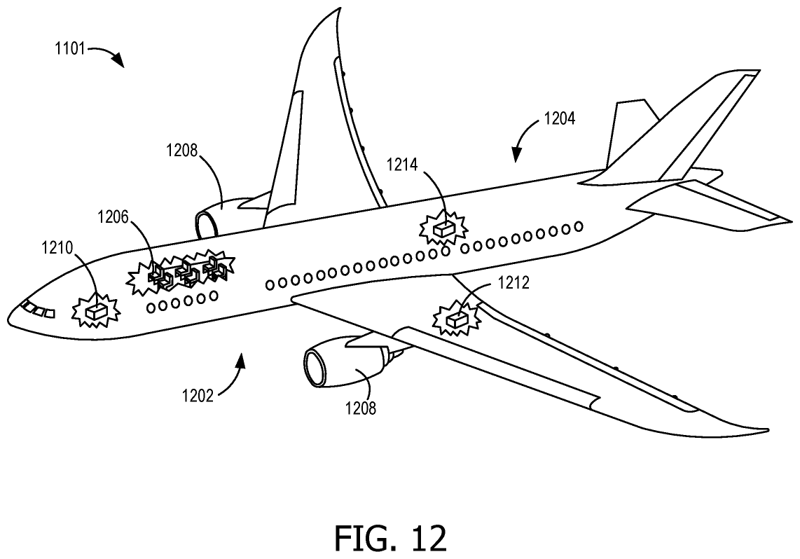

Referring more particularly to the drawings, FIG. 1 illustrates an arrangement 100 that advantageously employs multi-agent instruction generation, for example, multi-agent autonomous instruction generation for manufacturing. The arrangement 100 includes a control agent 200 that issues instructions 170 to and receives observations 180 a plurality of agents 110, 120, 130, 140, and 150 in a manufacturing environment 101, to manufacture a workpiece 102. The control agent 200 is described in greater detail in relation to FIG. 2. In one embodiment, the arrangement 100 is employed during production, component and subassembly manufacturing 1006 during pre-production, the apparatus manufacturing and service method 1000, as illustrated in FIG. 10. In one embodiment, the workpiece 102 becomes an apparatus 1100 (or a component), as shown in FIG. 11, for example a flying apparatus 1101 as shown in FIG. 12. Plurality of agents 110, 120, 130, 140, and 150 includes a plurality of actor agents 110, 120, 130, and 140 and also a sensor agent 150.

The human actor agent 110 includes a human actor 112 accessing a UI 114. The autonomous actor agent 120 includes an autonomous actor 122 and a first sensor 124 that is able to collect sensor data regarding the operations or results of operations of at least the autonomous actor 122, and a tool cache 126. The semi-autonomous actor agent 130 includes a semi-autonomous actor 132 and a second sensor 134 that is able to collect sensor data regarding the operations or results of operations of at least the semi-autonomous actor 132, and a tool cache 136. The non-autonomous actor agent 140 includes a non-autonomous actor 142 and a third sensor 144 that is able to collect sensor data regarding the operations or results of operations of at least the non-autonomous actor 142, and a tool cache 146. The sensor agent 150 includes a fourth sensor 154 that is able to collect sensor data regarding aspects of the manufacturing environment 101 within its range. The collected sensor data becomes observations 180 (shown in three discrete time steps as first observation data 181, second observation data 182, and third observation data 183) and is received, by the control agent 200 over a communication component 104.

In one example, the plurality of agents 110, 120, 130, 140, and 150 perform manufacturing tasks that may include any of: video capture, measurement, painting, soldering, welding, moving, cutting, drilling, puncturing, and hammering. It should be understood that, although only one actor of each type (human, autonomous, semi-autonomous, non-autonomous, and sensor) is illustrated, a different number of each type of actor may be used in some examples. The manufacturing tasks are controlled using instructions 170 (shown in three discrete time steps as first set of instructions 171, second set of instructions 172, and third set of instructions 173) that are generated by the control agent 200 and sent over the communication component 104 to the plurality of agents 110, 120, 130, 140, and 150. In one example, the instructions 170 include at least one of a role assignment, platform control, tool selection, and tool utilization.

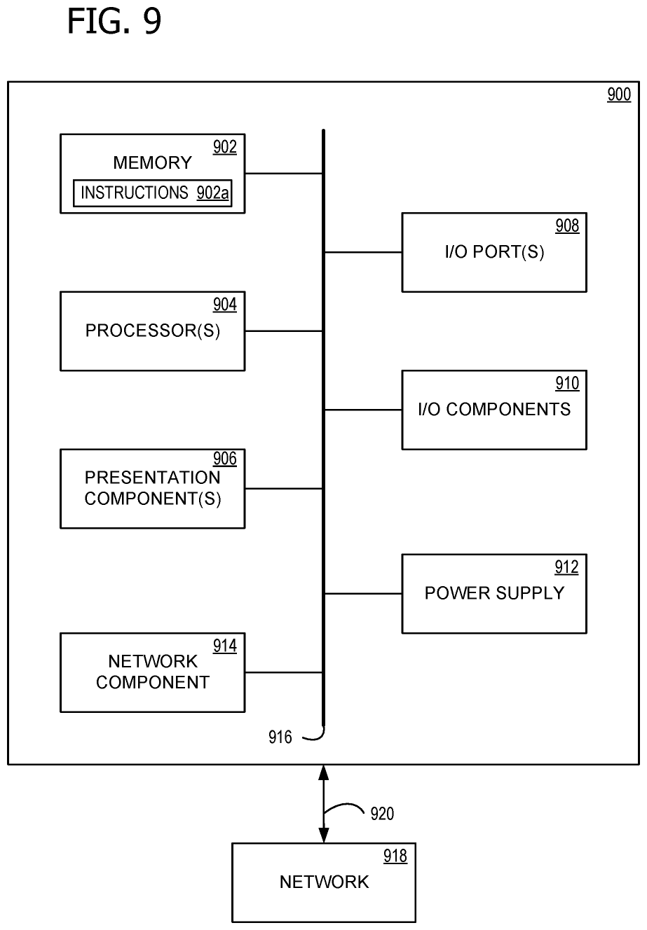

The human actor 112 may both receive instructions 170 from and provide observations 180 to the control agent 200 via the UI 114. In one example, the UI 114 is implemented using a computing device 900 of FIG. 9. For the autonomous actor agent 120, the autonomous actor 122, the semi-autonomous actor 132, and the non-autonomous actor 142 each follows relevant ones of the instructions 170, which may include the selection and utilization of tools from a respective one of tool caches 126, 136, and 146.

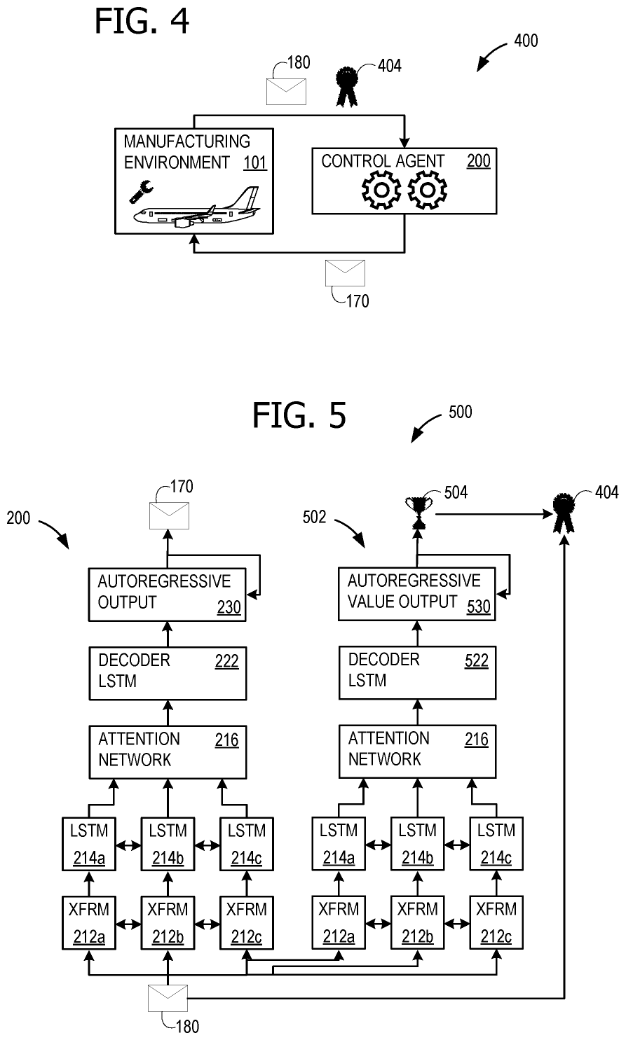

A training component 106 provides pre-deployment training and/or supplemental training for the control agent 200, using training data 108. In one example, the training data 108 is synthetic training data. Pre-deployment training may be used to get the control agent 200 up to a minimum level of capability before being used for operations. The training data 108 may simulate, for example, multiple rounds of the instructions 170 and the observations 180, along with rewards 404 that are leveraged for ongoing performance improvement of the control agent 200. Performance improvement of the control agent 200 using the rewards 404 is described in further detail in relation to FIGS. 4 and 5.

A data store 190 is coupled to the control agent 200 and/or the communication component 104 and stores at least the instructions 170 and the observations 180. This permits the control agent 200 to use actual historic data, including outgoing control commands (the instructions 170) and performance results (embedded within the observations 180) for ongoing learning and improvement. Additionally, the actual historic data stored in the data store 190 may become a version of training data 108 for another example of the control agent 200 that will be deployed to another manufacturing environment 101.

Referring now to FIG. 2, the control agent 200 is shown to comprise multiple portions, including an encoder portion 210 comprising a plurality of input-specific LSTMs 214a-214c and an attention network 216, and a decoder portion 220 comprising a decoder LSTM 222. Together, the encoder portion 210 and the decoder portion 220 form a policy network 240. An LSTM is an artificial recurrent neural network (RNN) architecture used for deep learning applications, and leverages feedback connections to process sequences of data. LSTM units are units of an RNN; an RNN composed of LSTM units is often referred to as an LSTM network. In one example, the policy network 240 includes an autoregressive bidirectional RNN attention network, and the control agent may thus include an autoregressive bidirectional LSTM attention network. An autoregressive (AR) network predicts future behavior based on past behavior and observations. The control agent 200 may control multiple actions simultaneously, with some actions depending on others. An attention network is a neural attention mechanism that equip a neural network with the ability to focus on a subset of its inputs (or features).

The incoming observations 180 are transformed by a respective one of transform 212a, transform 212b, and transform 212c. In one embodiment, this includes scaling measurements from a minimum and maximum of allowable input values to a range of −1 to +1. The input-specific LSTMs (LSTM 214a, LSTM 214b, and LSTM 214c) each receives at least a portion of the (transformed) observations 180. The attention network 216 and the decoder LSTM 222 receive at least a portion of a set of commands. The attention network 216 enables the control agent 200 to focus on a subset of LSTMs 214a-214c. In one example, some of the observations 180 are passed directly to the decoder LSTM 222. Thus, the decoder LSTM 222 receives at least a portion of the observations 180 (observation data) from the input-specific LSTMs 214a-214c and the attention network 216.

An autoregressive output 230 takes the output from the decoder LSTM 222, observations 180, and actor masks 232 to generate the instructions 170 that are routed (via the communication component 104) to the proper ones of agents 110, 120, 130, 140, and 150. In one example, the actor masks 232 include preconfigured constraints that prevent an agent from performing a task (e.g., the agent is out of supplies or has some malfunction). The actor masks 232 thus constrain the instructions 170.

For example a set of input to the control agent 200 may be represented as:

Situational Awareness Comprising:

Position (of actor N);

Orientation (of actor N);

Primary objectives (current or allowable jobs);

Secondary objectives (current or allowable jobs);

Camera/vision video and/or pictures;

Derived video/pictures/graphs;

Masks for legal actions (provided by humans or logic-system);

List of job priorities;

Task Specific Descriptions:

Task Id;

Task tolerance;

Task ordering;

Operating region;

Human or logic based system provided;

Agent's previous actions;

Role and sub-role;

Control and sub-control:

Positions, orientation, target selected, selected tool, tool usage strength;

Human Situational Awareness:

Task Specific Descriptions;

Task Ids to Suggested Actor Agents;

Task Priorities;

For example, a human may recognize attributes of the manufacturing environment 101 that need to be addressed by area, issues, and/or jobs. The control agent 200 will queue them and handle them as it has capacity.

The auto-regressive nature of the output of the control agent 200 may be broken down into agent role and sub-roles and agent control and sub-control. Agent sub-roles are conditioned on selected or provided roles. Agent control is conditioned on the sub-role and subsequent controls that are provided. An example is:

Role Actions: Agent Role (Embeddings/Ids)

Role: Situational Awareness (SA) Gathering

Sub-role: Video Capture

Sub-role: Measurement

Role: Labor

Sub-role: Painting

Sub-role: Soldering

Sub-role: Lifting/rotating

Sub-role: Transportation

Sub-role: Cutting

Sub-role: Puncturing/Drilling

Sub-role: Hammering

Control Actions: Agent Control

Control: Platform Control

Target Selection: Attention to target (Points to target)—item to lift,

Position: X, Y, Z

Orientation: angular rotations in X, Y, Z dimension

Control: Tool-selection

Drill Type (Power) and Bit

Saw

Solder

Brush

Grasper type

Hammer type

Control: Tool-utilization

Strength of utilization (constrained between min and max power of tool)

Position: X, Y, Z

Orientation: angular rotations in X, Y, Z dimension

Area: Delta X, delta, Y, Delta Z

Pseudocode is provided below for training the control agent, for example by the training component 106 of FIG. 1, and during operations of the manufacturing environment 101. For training:

```
train_system( ) {
  repeat (num_training_runs):
    ai = database.get_latest_ai_or_initialize( )
    // retrieve the latest version of the AI system or initialize the internal
    weights
    // retrieves previous (all_platform_actions, env_rewards,
    all_enc_attention, all_env_data, action_assessments)
    // based previous periods of time interaction with the environment
    env_data = database.retrieve_data(time_period)
    action_probs = ai.decoder.action_probabilities(all_enc_attention,
    all_env_data)
    advantage = utils.discounted_cumulative_rewards(env_rewards) −
    action_assessements
    masked_log_action_probs = utils.masked_log_softmax
    (all_env_data.action_masks, action_probs)
    actor_costs = -1.0*masked_log_action_probs * advantages
    assessor_costs = param.accessors_regularization_const*
  utils.square_difference(utils.discounted_cumulative_rewards
  (env_rewards), action_assessements)
    entropy_values = utils.masked_shannon_entropy(action_probs,
    all_env_data.action_masks)
    entropy_regularization = param.entropy_regularization_const *
    entropy_values
    cost = utils.sum(actor_costs + assessor_costs +
    entropy_regularization);
    gradients = ai.optimize_by_minimizing_cost(cost) // calculate change
    needed to minimize desired versus actual behavior
    updated_ai = ai.update_weights(gradients) // apply the change in
    internal parameters
    database.update_ai_system(updated_ai)
}
```

For operations:

```
run_system( ) {
  repeat (is_done):
    ai = database.get_latest_ai_or_initialize( ) // retrieve the latest version
    of the AI system or initialize the internal weights
    env = RealWorldEnv( )
    if (using_simulator):
      env = SimulatedEnv( )
      env.reset(env_configs)
    tech_data, tech_masks = env.get_data_from_end_systems( ) //
    IoT/sensors on platforms
    human_data, human_masks = env.get_data_from_humans( ) // bio or
    human centric devices
    trans_tech_data, tech_id = ai.encoder.transform_data(tech_data,
    tech=true) // conform data structure
    trans_human_data, human_id = ai.encoder.transform_data
    (human_data, human=true) // conform data structure
    all_env_data = utils.concatenate((trans_tech_data, tech_id),
    (trans_human_data, human_id))
    enc_data = ai.encoder.unroll_and_transform(all_env_data)
    controllable_platforms = ai.env.get_controllable_platforms( ) //
    returns all the controllable platforms
    all_platform_actions = { } // ids:actions mapping
    all_enc_attention = { } // ids:enc_attention mapping
    for (platform in controllable_platforms):
      enc_attention = ai.encoder.attend_to_relevant_data(enc_data) //
      AI's learned attention to the most relevant inputs
      action_masks = env.get_action_masks(platform)
      platform_actions = ai.decoder.unroll_transform_and_act
      (enc_attention, platform.id, action_masks)
      all_platform_actions[platform.id] = platform_actions
      // Learn to self-assess how good it was to take a particular
      action/control a platform in a particular way given the environment
      action_assessments = ai.decoder.unroll_transform_and_access
      (all_enc_attention, all_platform_actions, all_env_data)
      env_rewards, is_done = env.apply_actions(all_platform_actions)
      // rewards from human and or scripted logic system
      data_package = utils.collect_information(all_platform_actions,
      env_rewards, all_enc_attention, all_env_data, action_assessments)
      database.store_data(data_package) // could be storing data to a
      remote location
}
```

FIG. 3 illustrates some step-wise operational details for the control agent 200. FIG. 2 was described according to a specific moment in time. As time progresses, and the workpiece 102 develops incrementally, the control agent 200 cycles through subsequent versions of the instructions 170 and the resulting observations 180. The control agent 200 does not merely generate the instructions 170 based on the observations 180, but also uses at least the prior cycle of instructions 170 (or more than only just the immediately prior cycle). Thus, as illustrated in FIG. 3, the decoder LSTM 222 and the attention network 216 both receive, at time step t, the output of the decoder LSTM 222 from time step (t−1). Similarly, the decoder LSTM 222 and the attention network 216 both receive, at time step (t+1), the output of the decoder LSTM 222 from time step t.

FIG. 4 illustrates an operational loop 400 for performance improvement of the control agent 200. In the operational loop, the control agent 200 receives the observations 180 and the rewards 404, which are used to score the prior cycle of the instructions 170. The control agent 200 learns from the observations 180, based on the rewards 404 that indicate whether the assigned tasks had been accomplished properly, and produces the next cycle of the instructions 170. The rewards 404 result from feedback on results (e.g., the observations 180) that correlates with control actions (e.g., the instructions 170).

FIG. 5 illustrates a learning structure 500 that may be used to improve performance of the control agent 200 in the operational loop 400. Gradient based optimization techniques utilize reinforcement learning (reward heuristics) for an actor and critic network topology in which the actor provides the actions and the critic assesses those actions for each autonomous agent by providing a value assessment for the quality of the action. In one example, the gradient optimization technique utilizes natural gradient techniques and stochastic gradient descent mechanisms.

Performance improvement of the control agent 200 may be viewed as a multi-variant optimization function. Some of the parameters to be considered include time to completion, completion of tasks according to priority, successful completion of a task (e.g., for each agent), completion of high level objectives (e.g., aggregations of tasks) which may require the successful coordination of all or some of the agents 110, 120, 130, 140, and 150 autonomous agents controlled by the control agent 200.

As illustrated, the instructions 170 are generated by the control agent 200 as described above. In parallel, a value assessment 504 is also generated by a value network 502. The value network 502 is similar to the control agent 200, although not the same. A decoder LSTM 522 intakes the actor actions in addition to observations 180 and outputs from the attention network 216. An autoregressive value output 530 intakes the outputs from the decoder LSTM 522, actor masks 232, observations 180, and optionally the actor actions, and outputs the value assessment 504 rather than the instructions 170. In one example, the value network 502 outputs a real valued number scaled between −1 and +1 (e.g., scaled from an initial calculation range that may be wider). The decoder LSTM 522 may be similar to the decoder LSTM 322 if policy network outputs are not provided at this level, or may be different in some examples.

The rewards 404 are derived using the value assessment 504 and the observations 180. The rewards 404 may also be derived from software logic or informed by a human. Various calculations may be used in the derivation of the rewards 404 and the ongoing learning by the control agent 200. These may include calculation of a discounted cumulative reward, Gₜ (at time t), from performance results:

Gₜ=Σₖ₌ₜ₊₁^{T}γ^{k}Rₖ Equation 1:

where γ is a discount factor, and R is a reward function.

The value loss to minimize, L^{value}(w), is given by:

L^{value}(w)=Σₜ(V_{w}(sₜ)−Gₜ)² Equation 2:

where s is the state, and V_{w} is the performance estimate by the control agent 200.

An advantage, Aₜ, is a derived reward, the difference between actual and believed performance (e.g., how much better or worse the control agent 200 did than it believed to be the case), and is given by:

Aₜ=Gₜ−V_{w}(sₜ) Equation 3:

The policy loss to minimize, L^{policy}, is used for backpropagation in neural network training:

L^{policy}(θ)=−Σₜ log(π_{θ}(aₜ|sₜ))Aₜ Equation 4:

where π is a probability function and a is the actual result (outcome). The gap between self-assessment and environment feedback should decrease over time.

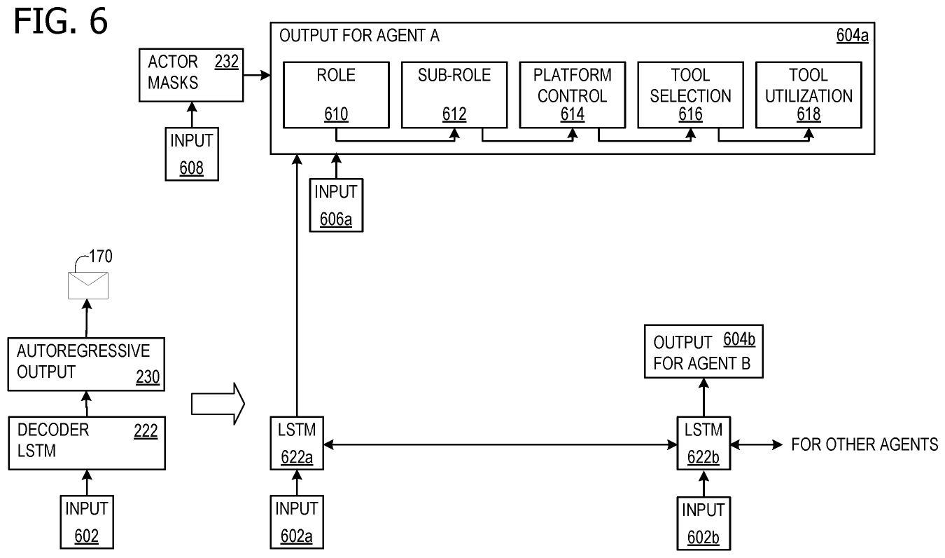

FIG. 6 illustrates additional operational details for the control agent 200. As indicated, the autoregressive output 230 is unrolled for each actor. That is, the decoder LSTM 222 receives input 602 (e.g., from the encoder portion 210 of FIG. 2), which may be represented as a set of inputs 602a and 602b (plus others for other agents), while the decoder LSTM 222 may be represented as a set of LSTMs 622a and 622b (plus others for other agents). LSTM 622a outputs output 604a for agent A (one of agents 110, 120, 130, 140, and 150), LSTM 622b outputs output 604b for agent B, and this structure is continued for the remaining ones of agents 110, 120, 130, 140, and 150. The set of outputs 604a, 604b, and others form at least a portion of the instructions 170. Another input 606a is provided to output 604a, and an input 608 is used to generate the actor masks 232. The proper one of the actor masks 232 is also applied to the output 604a. The output 604a is illustrated as having multiple components: a role 610, a sub-role 612, a platform control 614, a tool selection 616, and a tool utilization 618. Other outputs to other agents may be similar or may differ, based on the nature of the specific agent receiving the output.

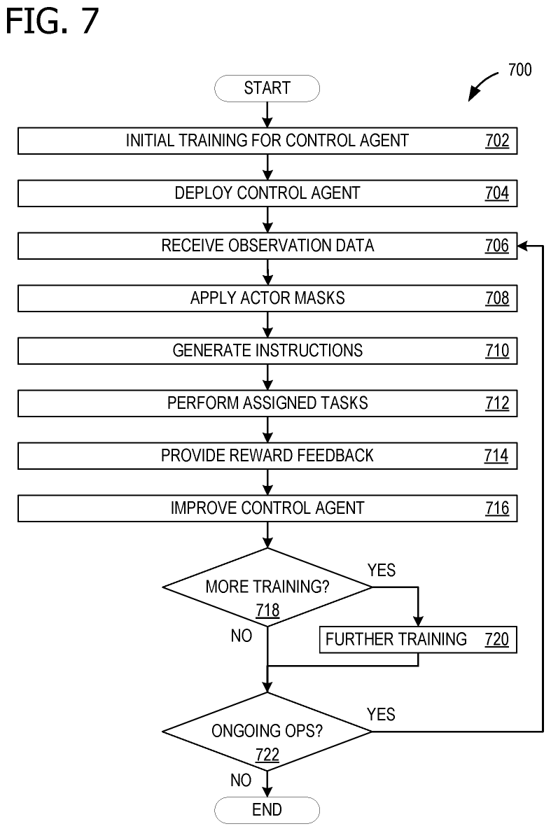

With reference now to FIG. 7, a flow chart 700 illustrates a method of multi-agent instruction generation, as may be used with the arrangement 100, for example during production, component and subassembly manufacturing 1006 of FIG. 10. In one example, the operations illustrated in FIG. 7 are performed, at least in part, by executing instructions 902a (stored in the memory 902) by the one or more processors 904 of the computing device 900 of FIG. 9. Operation 702 includes conducting initial training of the control agent 200. In one example, operation 702 includes training the control agent 200 with synthetic training data 108. For operation 702, training the control agent 200 with synthetic training data 108 occurs prior to generating the first set of instructions 171. The control agent 200 is deployed in operation 704.

Operation 706 includes receiving, by the control agent 200 from at least the plurality of actor agents 110, 120, 130, 140, and 150, the observation data 181 regarding performance of the actor agents 110, 120, 130, 140, and 150 on the first set of manufacturing tasks, wherein the control agent 200 comprises an autoregressive bidirectional LSTM attention network. In one example, the receiving observation data comprises also receiving the observation data 181 from the sensor agent 150 comprising the fourth sensor 154. In one example, the control agent 200 comprises: the encoder portion 210 comprising the plurality of input-specific LSTMs 214a-214c and the attention network 216; and the decoder portion 220 comprising the decoder LSTM 222. In one example, the input-specific LSTMs 214a-214c receive at least a portion of the observation data 181, and wherein the attention network 216 and the decoder LSTM 222 receive at least a portion of the first set of instructions 171.

Operation 708 includes applying the actor masks 232, which will result in constraining the instructions 171 using the actor masks 232, when operation 708 occurs. Operation 710 includes generating, for the plurality of actor agents 110, 120, 130, 140, and 150, the first set of instructions 171 for performing a first set of manufacturing tasks, wherein the actor agents 110, 120, 130, 140, and 150 include at least one actor agent selected from the list consisting of: the human actor 112 accessing the UI 114, the autonomous actor 122 having the first sensor 124, the semi-autonomous actor 132 having the second sensor 134, and the non-autonomous actor 142 having the third sensor 144. In one example, the manufacturing tasks include at least one task selected from the list consisting of: video capture, measurement, painting, soldering, welding, moving, cutting, drilling, puncturing, and hammering.

The plurality of actor agents 110, 120, 130, 140, and 150 then perform their assigned manufacturing tasks in accordance with the instructions 171 in operation 712. Rewards are generated and provided as feedback in operation 714, to provide ongoing performance improvements for the control agent 200 in operation 716. A decision operation 718 determines whether the control agent 200 would benefit from further training. If so, operation 720 includes conducting further training of the control agent 200. In one example, operation 720 includes training the control agent 200 with synthetic training data 108. For operation 720, training the control agent 200 with synthetic training data 108 occurs after generating the first set of instructions 171.

A decision operation 722 determines whether operations of the control agent 200 remain ongoing. If so, the flow chart 700 returns to operation 706. However, this second time, operation 708 includes updating the actor masks 232, which will result in constraining the instructions 172 using the actor masks 232. In the second pass, operation 706 includes receiving, by the control agent 200 from at least the plurality of actor agents 110, 120, 130, 140, and 150 (and, in one example, also the sensor agent 150) the second observation data 182 regarding performance of the actor agents 110, 120, 130, 140, and 150 on the second set of manufacturing tasks. Also in the second pass, operation 710 includes, based at least on the first set of instructions 171 and the observation data 181, generating, for the plurality of actor agents 110, 120, 130, 140, and 150, the second set of instructions 172 for performing a second set of manufacturing tasks. In further iterations, operation 710 includes, based at least on the second set of instructions 172 and the second observation data 182, generating, by the control agent 200 for the plurality of actor agents 110, 120, 130, 140, and 150, the third set of instructions 173 for performing a third set of manufacturing tasks. This use of prior instructions and observations in the generation of subsequent instructions continues as the control agent 200 continually improves.

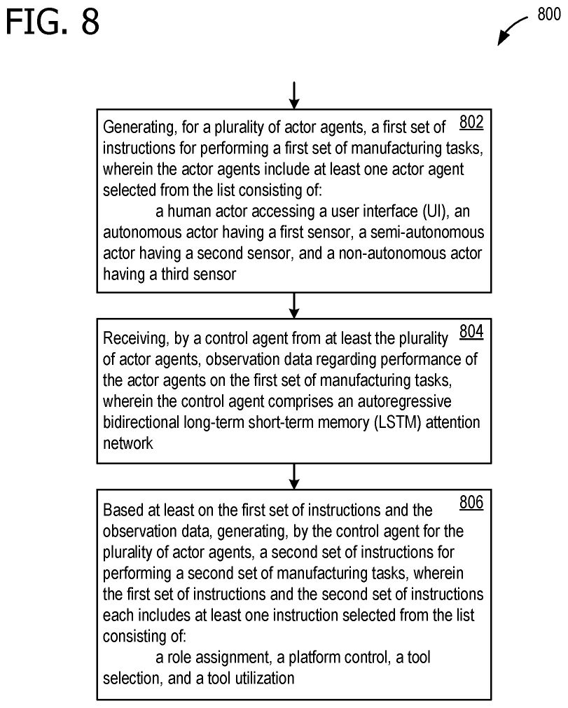

FIG. 8 shows a flow chart 800 also illustrating a method of multi-agent instruction generation that may, for example, be part of production, component and subassembly manufacturing 1006 of FIG. 10. In one example, operations illustrated in FIG. 8 are performed, at least in part, by executing instructions by the one or more processors 904 of the computing device 900 of FIG. 9. In one example, operation 802 includes generating, for a plurality of actor agents, a first set of instructions for performing a first set of manufacturing tasks, wherein the actor agents include at least one actor agent selected from the list consisting of: a human actor accessing a UI, an autonomous actor having a first sensor, a semi-autonomous actor having a second sensor, and a non-autonomous actor having a third sensor.

Operation 804 includes receiving, by a control agent from at least the plurality of actor agents, observation data regarding performance of the actor agents on the first set of manufacturing tasks, wherein the control agent comprises an autoregressive bidirectional LSTM attention network. Operation 806 includes, based at least on the first set of instructions and the observation data, generating, by the control agent for the plurality of actor agents, a second set of instructions for performing a second set of manufacturing tasks, wherein the first set of instructions and the second set of instructions each includes at least one instruction selected from the list consisting of: a role assignment, a platform control, a tool selection, and a tool utilization.

With reference now to FIG. 9, a block diagram of the computing device 900 suitable for implementing various aspects of the disclosure is described. In some examples, the computing device 900 includes one or more processors 904, one or more presentation components 906 and the memory 902. The disclosed examples associated with the computing device 900 are practiced by a variety of computing devices, including personal computers, laptops, smart phones, mobile tablets, hand-held devices, consumer electronics, specialty computing devices, etc. Distinction is not made between such categories as “workstation,” “server,” “laptop,” “hand-held device,” etc., as all are contemplated within the scope of FIG. 9 and the references herein to a “computing device.” The disclosed examples are also practiced in distributed computing environments, where tasks are performed by remote-processing devices that are linked through a communications network. Further, while the computing device 900 is depicted as a seemingly single device, in one example, multiple computing devices work together and share the depicted device resources. For instance, in one example, the memory 902 is distributed across multiple devices, the processor(s) 904 provided are housed on different devices, and so on.

In one example, the memory 902 includes any of the computer-readable media discussed herein. In one example, the memory 902 is used to store and access instructions 902a configured to carry out the various operations disclosed herein. In some examples, the memory 902 includes computer storage media in the form of volatile and/or nonvolatile memory, removable or non-removable memory, data disks in virtual environments, or a combination thereof. In one example, the processor(s) 904 includes any quantity of processing units that read data from various entities, such as the memory 902 or input/output (I/O) components 910. Specifically, the processor(s) 904 are programmed to execute computer-executable instructions for implementing aspects of the disclosure. In one example, the instructions are performed by the processor, by multiple processors within the computing device 900, or by a processor external to the computing device 900. In some examples, the processor(s) 904 are programmed to execute instructions such as those illustrated in the flow charts discussed below and depicted in the accompanying drawings.

The presentation component(s) 906 present data indications to an operator or to another device. In one example, presentation components 906 include a display device, speaker, printing component, vibrating component, etc. One skilled in the art will understand and appreciate that computer data is presented in a number of ways, such as visually in a graphical user interface (GUI), audibly through speakers, wirelessly between the computing device 900, across a wired connection, or in other ways. In one example, presentation component(s) 906 are not used when processes and operations are sufficiently automated that a need for human interaction is lessened or not needed. I/O ports 908 allow the computing device 900 to be logically coupled to other devices including the I/O components 910, some of which is built in. Examples of the I/O components 1810 include, for example but without limitation, a microphone, keyboard, mouse, joystick, game pad, satellite dish, scanner, printer, wireless device, etc.

The computing device 900 includes a bus 916 that directly or indirectly couples the following devices: the memory 902, the one or more processors 904, the one or more presentation components 906, the input/output (I/O) ports 908, the I/O components 910, a power supply 912, and a network component 914. The computing device 900 should not be interpreted as having any dependency or requirement related to any single component or combination of components illustrated therein. The bus 916 represents one or more busses (such as an address bus, data bus, or a combination thereof). Although the various blocks of FIG. 9 are shown with lines for the sake of clarity, some examples blur functionality over various different components described herein.

In some examples, the computing device 900 is communicatively coupled to a network 918 using the network component 914. In some examples, the network component 914 includes a network interface card and/or computer-executable instructions (e.g., a driver) for operating the network interface card. In one example, communication between the computing device 900 and other devices occur using any protocol or mechanism over a wired or wireless connection 920. In some examples, the network component 914 is operable to communicate data over public, private, or hybrid (public and private) using a transfer protocol, between devices wirelessly using short range communication technologies (e.g., near-field communication (NFC), Bluetooth® branded communications, or the like), or a combination thereof.

Although described in connection with the computing device 900, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network personal computers (PCs), minicomputers, mainframe computers, distributed computing environments that include any of the above systems or devices, virtual reality (VR) devices, holographic device, and the like. Such systems or devices accept input from the user in any way, including from input devices such as a keyboard or pointing device, via gesture input, proximity input (such as by hovering), and/or via voice input.

Implementations of the disclosure are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the figures and described herein. Other implementations of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

Some examples of the disclosure are used in manufacturing and service applications as shown and described in relation to FIGS. 10-12. Thus, implementations of the disclosure are described in the context of an apparatus of manufacturing and service method 1000 shown in FIG. 10 and apparatus 1100 shown in FIG. 11. In FIG. 11, a diagram illustrating an apparatus manufacturing and service method 1000 is depicted in accordance with an example. In one example, during pre-production, the apparatus manufacturing and service method 1000 includes specification and design 1002 of the apparatus 1100 in FIG. 11 and material procurement 1104. During production, component and subassembly manufacturing 1006 and system integration 1008 of the apparatus 1100 in FIG. 11 takes place. Thereafter, the apparatus 1100 in FIG. 11 goes through certification and delivery 1010 in order to be placed in service 1012. While in service by a customer, the apparatus 1100 in FIG. 11 is scheduled for routine maintenance and service 1014, which, in one example, includes modification, reconfiguration, refurbishment, and other maintenance or service subject to configuration management, described herein.

In one example, each of the processes of the apparatus manufacturing and service method 1000 are performed or carried out by a system integrator, a third party, and/or an operator. In these examples, the operator is a customer. For the purposes of this description, a system integrator includes any number of apparatus manufacturers and major-system subcontractors; a third party includes any number of venders, subcontractors, and suppliers; and in one example, an operator is an owner of an apparatus or fleet of the apparatus, an administrator responsible for the apparatus or fleet of the apparatus, a user operating the apparatus, a leasing company, a military entity, a service organization, or the like.

With reference now to FIG. 11, the apparatus 1100 is provided. As shown in FIG. 11, an example of the apparatus 1100 is a flying apparatus 1101, such as an aerospace vehicle, aircraft, air cargo, flying car, earth-orbiting satellite, planetary probe, deep space probe, solar probe, and the like. As also shown in FIG. 11, a further example of the apparatus 1100 is a ground transportation apparatus 1102, such as an automobile, a truck, heavy equipment, construction equipment, a boat, a ship, a submarine and the like. A further example of the apparatus 1100 shown in FIG. 11 is a modular apparatus 1103 that comprises at least one or more of the following modules: an air module, a payload module and a ground module. The air module provides air lift or flying capability. The payload module provides capability of transporting objects such as cargo or live objects (people, animals, etc.). The ground module provides the capability of ground mobility. The disclosed solution herein is applied to each of the modules separately or in groups such as air and payload modules, or payload and ground, etc. or all modules.

With reference now to FIG. 12, a more specific diagram of the flying apparatus 1101 is depicted in which an implementation of the disclosure is advantageously employed. In this example, the flying apparatus 1101 is an aircraft produced by the apparatus manufacturing and service method 1000 in FIG. 10 and includes an airframe 1202 with a plurality of systems 1204 and an interior 1206. Implementations of the plurality of systems 1204 include one or more of a propulsion system 1208, an electrical system 1210, a hydraulic system 1212, and an environmental system 1214. However, other systems are also candidates for inclusion. Although an aerospace example is shown, different advantageous examples are applied to other industries, such as the automotive industry, etc.

The examples disclosed herein are described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples are practiced in a variety of system configurations, including personal computers, laptops, smart phones, mobile tablets, hand-held devices, consumer electronics, specialty computing devices, etc. The disclosed examples are also practiced in distributed computing environments, where tasks are performed by remote-processing devices that are linked through a communications network.

An exemplary method of multi-agent instruction generation comprises: generating, for a plurality of actor agents, a first set of instructions for performing a first set of manufacturing tasks, wherein the actor agents include at least one actor agent selected from the list consisting of: a human actor accessing a UI, an autonomous actor having a first sensor, a semi-autonomous actor having a second sensor, and a non-autonomous actor having a third sensor; receiving, by a control agent from at least the plurality of actor agents, observation data regarding performance of the actor agents on the first set of manufacturing tasks, wherein the control agent comprises an autoregressive bidirectional LSTM attention network; and based at least on the first set of instructions and the observation data, generating, by the control agent for the plurality of actor agents, a second set of instructions for performing a second set of manufacturing tasks, wherein the first set of instructions and the second set of instructions each includes at least one instruction selected from the list consisting of: a role assignment, a platform control, a tool selection, and a tool utilization.

An exemplary system for multi-agent instruction generation comprises: one or more processors; and a memory storing instructions that, when executed by the one or more processors, cause the one or more processors to perform operations comprising: generating, for a plurality of actor agents, a first set of instructions for performing a first set of manufacturing tasks, wherein the actor agents include at least one actor agent selected from the list consisting of: a human actor accessing a UI, an autonomous actor having a first sensor, a semi-autonomous actor having a second sensor, and a non-autonomous actor having a third sensor; receiving, by a control agent from at least the plurality of actor agents, observation data regarding performance of the actor agents on the first set of manufacturing tasks, wherein the control agent comprises an autoregressive bidirectional LSTM attention network; and based at least on the first set of instructions and the observation data, generating, by the control agent for the plurality of actor agents, a second set of instructions for performing a second set of manufacturing tasks, wherein the first set of instructions and the second set of instructions each includes at least one instruction selected from the list consisting of: a role assignment, a platform control, a tool selection, and a tool utilization.

An exemplary computer program product comprises a computer usable medium having a computer readable program code embodied therein, the computer readable program code adapted to be executed to implement a method of multi-agent instruction generation, the method comprising: generating, for a plurality of actor agents, a first set of instructions for performing a first set of manufacturing tasks, wherein the actor agents include at least one actor agent selected from the list consisting of: a human actor accessing a UI, an autonomous actor having a first sensor, a semi-autonomous actor having a second sensor, and a non-autonomous actor having a third sensor; receiving, by a control agent from at least the plurality of actor agents, observation data regarding performance of the actor agents on the first set of manufacturing tasks, wherein the control agent comprises an autoregressive bidirectional LSTM attention network; and based at least on the first set of instructions and the observation data, generating, by the control agent for the plurality of actor agents, a second set of instructions for performing a second set of manufacturing tasks, wherein the first set of instructions and the second set of instructions each includes at least one instruction selected from the list consisting of: a role assignment, a platform control, a tool selection, and a tool utilization.

Alternatively, or in addition to the other examples described herein, examples include any combination of the following:
receiving, by the control agent from at least the plurality of actor agents, second observation data regarding performance of the actor agents on the second set of manufacturing tasks;
based at least on the second set of instructions and the second observation data, generating, by the control agent for the plurality of actor agents, a third set of instructions for performing a third set of manufacturing tasks;
an encoder portion comprising a plurality of input-specific LSTMs and an attention network;
a decoder portion comprising a decoder LSTM;
the input-specific LSTMs receive at least a portion of the observation data, and wherein the decoder LSTM receives at least a portion of the observation data from the input-specific LSTMs and attention network;
constraining instructions using actor masks;
receiving observation data comprises receiving observation data from a sensor agent comprising a fourth sensor;
training the control agent with synthetic training data;
the manufacturing tasks include at least one task selected from the list consisting of: video capture, measurement, painting, soldering, welding, moving, cutting, drilling, puncturing, and hammering;
training the control agent with synthetic training data occurs prior to generating the first set of instructions;
training the control agent with synthetic training data occurs after generating the first set of instructions;
a learning structure for improving performance of the control agent;
the learning structure comprises decoder LSTM that receives outputs from the encoder portion and the decoder portion; and
the learning structure outputs a value assessment;
rewards are derived using the value assessment and the observations; and
the rewards are generated and provided as feedback to provide ongoing performance improvements for the control agent.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there could be additional elements other than the listed elements. The term “implementation” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of multi-agent instruction generation, the method comprising:
generating, for a plurality of actor agents, a first set of instructions for performing a first set of manufacturing tasks, wherein the actor agents include at least one actor agent selected from the list consisting of:
a human actor accessing a user interface (UI), an autonomous actor having a first sensor, a semi-autonomous actor having a second sensor, and a non-autonomous actor having a third sensor;
receiving, by a control agent from at least the plurality of actor agents, observation data regarding performance of the actor agents on the first set of manufacturing tasks, wherein the control agent comprises an autoregressive bidirectional long-term short-term memory (LSTM) attention network; and
based at least on the first set of instructions and the observation data, generating, by the control agent for the plurality of actor agents, a second set of instructions for performing a second set of manufacturing tasks, wherein the first set of instructions and the second set of instructions each includes at least one instruction selected from the list consisting of:
a role assignment, a platform control, a tool selection, and a tool utilization.

2. The method of claim 1, further comprising:
receiving, by the control agent from at least the plurality of actor agents, second observation data regarding performance of the actor agents on the second set of manufacturing tasks; and
based at least on the second set of instructions and the second observation data, generating, by the control agent for the plurality of actor agents, a third set of instructions for performing a third set of manufacturing tasks.

3. The method of claim 1, wherein the control agent comprises:
an encoder portion comprising a plurality of input-specific LSTMs and an attention network; and
a decoder portion comprising a decoder LSTM.

4. The method of claim 3, wherein the input-specific LSTMs receive at least a portion of the observation data, and wherein the decoder LSTM receives at least a portion of the observation data from the input-specific LSTMs and attention network.

5. The method of claim 1, further comprising:
constraining instructions using actor masks.

6. The method of claim 1, wherein receiving observation data comprises receiving observation data from a sensor agent comprising a fourth sensor.

7. The method of claim 1, further comprising:
training the control agent with synthetic training data.

8. A system for multi-agent instruction generation, the system comprising:
one or more processors; and
a memory storing instructions that, when executed by the one or more processors, cause the one or more processors to perform operations comprising:
generating, for a plurality of actor agents, a first set of instructions for performing a first set of manufacturing tasks, wherein the actor agents include at least one actor agent selected from the list consisting of:
a human actor accessing a user interface (UI), an autonomous actor having a first sensor, a semi-autonomous actor having a second sensor, and a non-autonomous actor having a third sensor;
receiving, by a control agent from at least the plurality of actor agents, observation data regarding performance of the actor agents on the first set of manufacturing tasks, wherein the control agent comprises an autoregressive bidirectional long-term short-term memory (LSTM) attention network; and
based at least on the first set of instructions and the observation data, generating, by the control agent for the plurality of actor agents, a second set of instructions for performing a second set of manufacturing tasks, wherein the first set of instructions and the second set of instructions each includes at least one instruction selected from the list consisting of:
a role assignment, a platform control, a tool selection, and a tool utilization.

9. The system of claim 8, wherein the operations further comprise:
receiving, by the control agent from at least the plurality of actor agents, second observation data regarding performance of the actor agents on the second set of manufacturing tasks; and
based at least on the second set of instructions and the second observation data, generating, by the control agent for the plurality of actor agents, a third set of instructions for performing a third set of manufacturing tasks.

10. The system of claim 8, wherein the control agent comprises:
an encoder portion comprising a plurality of input-specific LSTMs and an attention network; and
a decoder portion comprising a decoder LSTM.

11. The system of claim 10, wherein the input-specific LSTMs receive at least a portion of the observation data, and wherein the decoder LSTM receives at least a portion of the observation data from the input-specific LSTMs and attention network.

12. The system of claim 8, wherein the operations further comprise:
constraining instructions using actor masks.

13. The system of claim 8, wherein receiving observation data comprises receiving observation data from a sensor agent comprising a fourth sensor.

14. The system of claim 8, wherein the operations further comprise:
training the control agent with synthetic training data.

15. A computer program product, comprising a computer usable medium having a computer readable program code embodied therein, the computer readable program code adapted to be executed to implement a method of multi-agent instruction generation, the method comprising:
generating, for a plurality of actor agents, a first set of instructions for performing a first set of manufacturing tasks, wherein the actor agents include at least one actor agent selected from the list consisting of:
a human actor accessing a user interface (UI), an autonomous actor having a first sensor, a semi-autonomous actor having a second sensor, and a non-autonomous actor having a third sensor;
receiving, by a control agent from at least the plurality of actor agents, observation data regarding performance of the actor agents on the first set of manufacturing tasks, wherein the control agent comprises an autoregressive bidirectional long-term short-term memory (LSTM) attention network; and
based at least on the first set of instructions and the observation data, generating, by the control agent for the plurality of actor agents, a second set of instructions for performing a second set of manufacturing tasks, wherein the first set of instructions and the second set of instructions each includes at least one instruction selected from the list consisting of:
a role assignment, a platform control, a tool selection, and a tool utilization.

16. The computer program product of claim 15, wherein the method further comprises:
receiving, by the control agent from at least the plurality of actor agents, second observation data regarding performance of the actor agents on the second set of manufacturing tasks; and
based at least on the second set of instructions and the second observation data, generating, by the control agent for the plurality of actor agents, a third set of instructions for performing a third set of manufacturing tasks.

17. The computer program product of claim 15, wherein the control agent comprises:
an encoder portion comprising a plurality of input-specific LSTMs and an attention network; and
a decoder portion comprising a decoder LSTM.

18. The computer program product of claim 17, wherein the input-specific LSTMs receive at least a portion of the observation data, and wherein the decoder LSTM receives at least a portion of the observation data from the input-specific LSTMs and attention network.

19. The computer program product of claim 15, wherein the method further comprises:
constraining instructions using actor masks.

20. The computer program product of claim 15, wherein receiving observation data comprises receiving observation data from a sensor agent comprising a fourth sensor.
